(19) United States
(12) Patent Application Publication
(10) Pub. No.: US 2019/0204101 A1
(43) Pub. Date: Jul. 4, 2019

(54) SYSTEMS AND METHODS TO PREPARE FOR AND TO RESPOND TO A TRANSIT DISRUPTION

(71) Applicant: Hornblower Group, Inc., San Francisco, CA (US)

(72) Inventor: Terry A. MACRAE, San Francisco, CA (US)

(21) Appl. No.: 16/235,813

(22) Filed: Dec. 28, 2018

Related U.S. Application Data
(60) Provisional application No. 62/612,057, filed on Dec. 29, 2017.

(51) Int. Cl. G01C 21/34; G06Q 50/30; G06Q 50/26

(52) U.S. Cl. CPC G01C 21/3492; G01C 21/3423; G06Q 50/265; G01C 21/3461; G06Q 50/30; G01C 21/3446

(57) ABSTRACT

The disclosed embodiments include systems and methods to prepare for and respond to a transit disruption. In one of such embodiments, the method includes receiving an indication of a transit disruption affecting a geographic region. The method also includes determining a plurality of transportation links in the geographic region and a plurality of situational transportation assets available to support the geographic region during the transit disruption. The method further includes forming a transportation network from the plurality of transportation links. The transportation network has one or more alternative transportation routes that one or more situational transportation assets of the plurality of situational transportation assets travel along to evaluate individuals. Each alternative transportation route connects one or more transportation stations to a transportation destination. The method further includes dispatching a situational transportation asset to a transportation station of the one or more transportation stations to transport one or more of the individuals.

### CLAIM OF PRIORITY

This application claims benefit of U.S. Provisional Patent Application No. 62/612,057, entitled “SYSTEMS AND METHODS TO PREPARE FOR AND TO RESPOND TO A TRANSIT DISRUPTION,” filed on Dec. 29, 2017, all of which, are hereby incorporated by reference in their entireties

### BACKGROUND

The present disclosure relates generally to systems and methods to prepare for as well as systems and methods to respond to a transit disruption.

Disasters, such as natural disasters and human-caused disasters often damage or destroy transportation infrastructures of a geographic region, thereby impeding evacuation of individuals affected by such disasters. Evacuation and relief efforts often strain the remaining transportation infrastructures of the geographic region not damaged or destroyed by the disasters, thereby causing delays to the evacuation and relief efforts. Further, disasters often occur without any or without sufficient advanced warning, and often overwhelm first responders as well as individuals affected by such disasters.

### BRIEF DESCRIPTION OF THE DRAWINGS

Illustrative embodiments of the present invention are described in detail below with reference to the attached drawing Figures, which are incorporated by reference herein, and wherein:

FIG. 1 is a network environment for planning for a transit disruption and also for responding to a transit disruption in accordance with one embodiment.

FIG. 2 is a tree diagram illustrating a process to form an alternative transportation route in accordance with one embodiment.

FIG. 3 is an illustration of a transportation network formed from multiple transportation links in accordance with one embodiment.

FIG. 4 is an illustration of a ferry system in accordance with one embodiment.

FIG. 5 is an illustration of a ferry system in accordance with another embodiment.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to systems and methods to prepare for as well as systems and methods to respond to a transit disruption. A transit disruption is any direct or indirect disruption to transportation infrastructures of a region. Moreover, transit disruptions may be caused by natural disasters, such as, but not limited to, hurricanes, earthquakes, tornados, wildfires, mudslides, or other naturally-caused disasters. Transit disruptions may also be caused by human-caused disasters, such as automobile accidents, boat accidents, maintenance failures (such as failures that cause a bridge to collapse, a dam to fail, and a tunnel to close), terrorism, as well as other incidents of human-caused disasters. Further, transit disruptions may also be caused by response efforts and by evacuation efforts to respond to such disasters and to transport individuals impacted by such disasters, respectively. For example, if a hurricane is approaching a coastal area, traffic due to individuals evacuating the coast area and first responders from nearby areas traveling to the coastal area would cause transit disruptions to highways connecting the coastal area to the nearby areas, and to waterways connecting the coastal area to other coastal areas not affected by the hurricane.

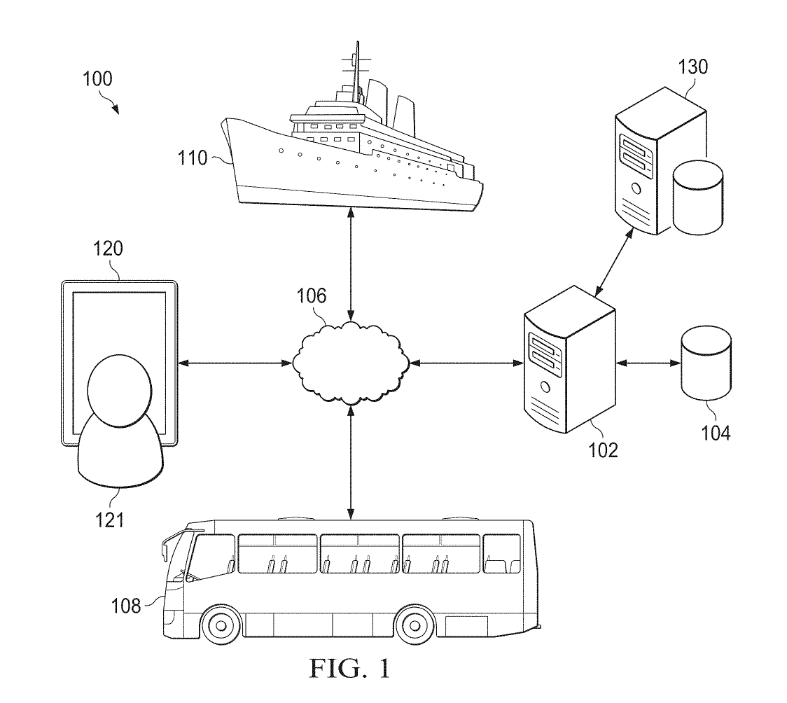

The transit disruption response system obtains indications of transit disruptions. In some embodiments, the transit disruption response system obtains indications of transit disruptions from third-party sources, such as weather forecasters, emergency response personnel and governmental entities, social media, traffic cameras, map-based applications, or any other available third-party sources. In other embodiments, the transit disruption response system is operable to detect transit disruptions (such as, but not limited to, seismic activity, or loss of communication with a passenger ship). Additional descriptions of third-party sources and processes to obtain indications of transit disruptions are provided in the paragraphs below and are illustrated in at least FIG. 1. In some embodiments, a transit disruption is an ongoing event (such as a traffic accident). In other embodiments, the transit disruption is a forecasted event. In such embodiments, the transit disruption response system is operable to predict an area affected by transit disruptions and perform the operations described herein.

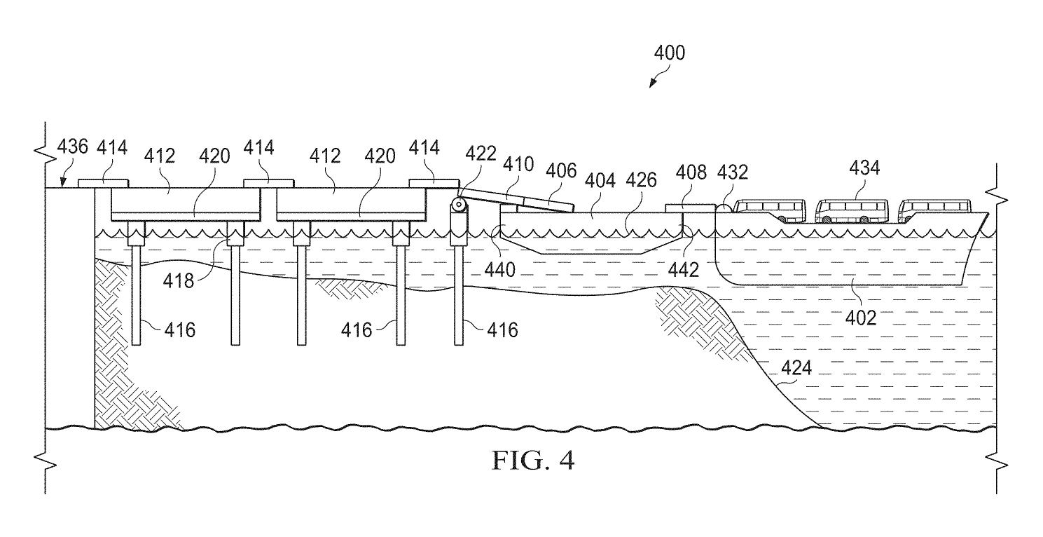

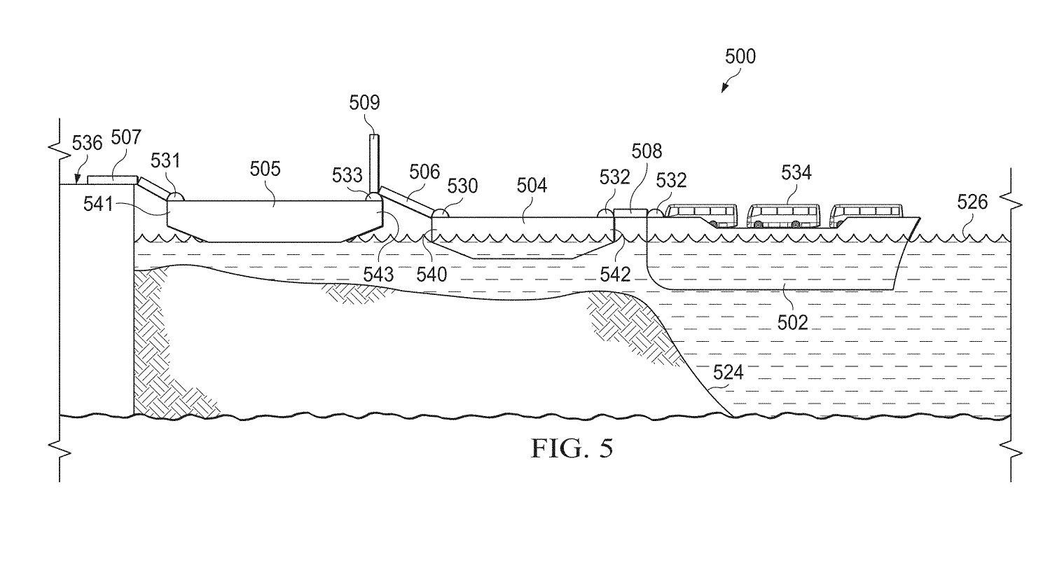

The transit disruption response system is operable to dispatch a variety of situational transportation assets to respond to transit disruptions. As defined herein, a situational transportation asset is any transportation vehicle deployable to respond to transit disruptions. Examples of situational transportation assets include, but are not limited to, ferries (passenger ferries and vehicle ferries) and ferry systems (passenger and cargo), buses, trains, air transport vehicles, as well as other land/air/sea vehicles. As defined herein, a passenger ferry is a ferry specialized in transporting passengers across a waterway, whereas a vehicle ferry is a ferry specialized in transporting vehicles (such as cars, buses, motorcycles, as well as other types of vehicles) across a waterway. Both passenger and vehicle ferries may form part of a ferry system that is configured to load and unload passengers and vehicles on and off passenger ferries, and vehicle ferries, respectively. Additional descriptions of ferry systems are provided in the paragraphs below and are illustrated in at least FIGS. 4 and 5. In some embodiments, the situational transportation assets are manned vehicles. In other embodiments, the situational transportation assets are unmanned vehicles, such as driverless buses, trains, ferries, and aircraft. The transit disruption response system also determines existing transportation links of a geographic region affected by the transit disruption. As defined herein, a transportation link is any land-based, sea-based, or air-based transit medium. Examples of transportation links include, but are not limited to roads, freeways, tollways, subways, railroad tracks, navigable waterways, bridges, tunnels, and air routes. Transportation links connect different locations (such as San Francisco to Oakland) and can be composed of a single transit medium (such as a subway track in a tunnel or a single roadway) or multiple transit mediums (roadway to a first ferry terminal, waterway between the first ferry terminal and a second ferry terminal, and the roadway from the second terminal to another location).

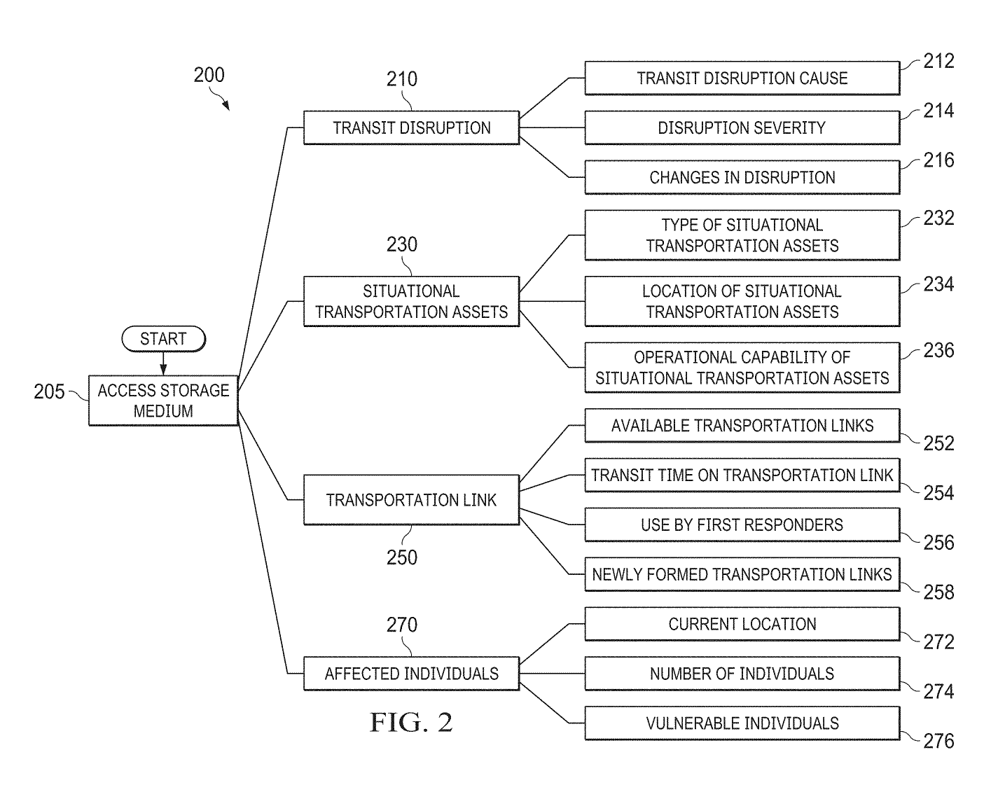

In the embodiments, where the transportation link is formed from multiple transit mediums, different types of situational transportation assets that are operable to travel along the different types of mediums are deployed to transport individuals across the different types of mediums. Continuing with the foregoing example where the transit link includes two roadways adjoined by a waterway, a bus operable to transport the individuals are deployed along the first roadway. The bus travels to a dock and boards a vehicle ferry. The vehicle ferry travels along the waterway to a dock proximate the second roadway. The bus then drives off the vehicle ferry and travels along the second roadway towards a transportation destination (as defined herein) proximate the second roadway. In some embodiments, the transit disruption response system scans existing public transportation plans to determine existing transportation links of the geographic region. In other embodiments, the transit disruption response system is operable to analyze the geographic region and to form new transportation links. For example, the transit disruption response system is operable to analyze the Bay Area to determine multiple docks along the city of San Francisco and Oakland and form a new sea-based transportation link connecting one or more docks in San Francisco with one or more docks in Oakland. Additional descriptions of operations performed by the transit disruption response system to evaluate existing transportation links and to form new transportation links are provided in the paragraphs below and are illustrated in at least FIG. 2.

The transit disruption response system forms alternative transportation routes from the transportation link in response (or in anticipation) of the transit disruption. As defined herein, an alternative transportation route is any land-based, sea-based, and air-based route (or any combination of the foregoing) formed from one or more transportation links in the event of a transit disruption to one or more existing transit links. The alternative transportation route connects one or more transportation stations, at which a situational transportation asset stops to transport individuals, to a transportation destination at which the situational transportation asset stops to drop off the individuals. The transit disruption response system analyzes data related to the transit disruption to determine how to form the alternative transportation routes.

In some embodiments, the transit disruption response system forms alternative transportation routes based on the type of the transit disruption. For example, if the transit disruption is related to an earthquake that destroyed a bridge connecting an island to the nearby mainland, the transit disruption response system is operable to form an alternative transportation route from a waterway connecting the island to the nearby mainland. The transit disruption response system designates a dock on the island as a transportation station and a dock on the mainland as a transportation destination. The transit disruption response system also dispatches ferries from the mainland to the transportation station to transport individuals on the island. In some embodiments, the transit disruption response system also forms alternative transportation routes based on the severity of the transit disruption. Continuing with the foregoing example, the transit disruption response system, in response to determining that individuals on the island face imminent danger, is also operable to form additional alternative transportation routes from air routes that connect the island to the mainland. In such embodiments, the transit disruption response system designates airfields on the island as transportation stations and dispatches aircraft to the airfields to transport individuals on the island.

In some embodiments, the transit disruption response system forms alternative transportation routes based on the available situational transportation assets (including, but not limited to, the type of available situational transportation assets, the location of the available situational transportation assets, and the capacity of the situational transportation assets). Continuing with the foregoing example, the transit disruption response system, in response to determining that multiple ferries from multiple nearby cities on the mainland are available to respond to the transit disruption, is operable to form multiple alternative transportation routes from different waterways connecting the island to each of the nearby cities. In one of such embodiments, the transit disruption response system is also operable to analyze the specifications of the ferries (such as, but not limited to, the passenger capacity, the cargo capacity, and first response features), and form different alternative transportation routes based on the specifications of the ferries. Continuing with the foregoing example, where the transit disruption response system determines that the available ferries include a passenger ferry, a vehicle ferry (specialized in carrying vehicles), and a third ferry with an onboard medical facility, the transit disruption response system forms three different alternative transportation routes connecting three different transportation stations on the island to different transportation destinations on the mainland. In such embodiments, the transit disruption response system dispatches the passenger ferry along a first alternative transportation route to transport uninjured individuals, dispatches the vehicle ferry along the second route to transport first response vehicles to the island and to transport vehicles from the island, and dispatches the third ferry along a third alternative transportation route to transport injured individuals and vulnerable individuals.

In some embodiments, the transit disruption response system forms alternative transportation routes based on routes utilized by first responders to respond to the transit disruption. For example, if the transit disruption is caused by a terrorist attack on the island described in the foregoing example, the transit disruption response system determines whether certain transportation links are used by the military as well as other governmental forces. The transit disruption response system then forms alternative transportation routes from alternative transportation links to reduce civilian casualties associated with the terrorist attack and also to avoid impeding the military and the governmental forces. In some embodiments, the transit disruption response system forms alternative transportation routes based on factors associated with the available transportation links in the geographic region, such as, but not limited to, transit time on the transit links, distance to the nearest transportation station, and distance to the nearest transportation destination. In further embodiments, the transit disruption response system forms alternative transportation routes based on factors associated with the individuals in the geographic region, such as, but not limited to, the number of individuals affected by transit disruption, locations of such individuals, and the number injured individuals. Additional factors analyzed by the transit disruption response system, as well as operations performed by the transit disruption response system to form alternative transportation routes, are described in the paragraphs below and are illustrated in at least FIG. 2.

As described herein, the transit disruption response system is operable to form multiple alternative transportation routes, each connecting one or more transportation stations to a transportation destination. The transit disruption response system forms a transportation network from multiple alternative transportation routes to facilitate simultaneous transportation of individuals from multiple transportation stations to one or more transportation destinations. As defined herein, a transportation network is a collection of existing transportation routes and alternative transportation routes (such as land-based alternative transportation routes, sea-based alternative transportation routes, and air-based alternative transportation routes) that situational transportation assets as well as non-situational transportation assets travel along to transport individuals. In some embodiments, multiple alternative transportation routes are connected to each other to facilitate transportation of individuals over a greater distance than the distance of any individual alternative transportation route of the multiple alternative transportation routes. For example, a first alternative transportation route transports individuals from an inland area of the island of the foregoing example to a dock on the island, which serves as the transportation destination of the first alternative transportation route. The first alternative transportation route connects multiple transportation stations along the way from the island area to the dock. A second alternative transportation route is formed from a waterway connecting the island to the mainland. Further, the dock is a transportation station along the second alternative transportation route. In such embodiments, individuals transported from the inland areas of the island are dropped off at the dock where they board ferries (or ferry stations) traveling along the second alternative transportation route to transport to the mainland.

The transit disruption response system assigns situational transportation assets to operate along an alternative transportation route (or multiple alternative transportation routes) and to transport individuals from transportation stations along the alternative transportation route (or multiple alternative transportation routes) to a transportation destination. The transit disruption response system analyzes a variety of factors to determine which situational transportation asset should be dispatched along the alternative transportation route. Examples of factors considered by the transit disruption response system include, but are not limited to the type of the transit disruption, the severity of the transit disruption, the number of individuals impacted by the transit disruption, the locations of the individuals impacted by the transit disruption, whether some of the individuals are vulnerable (such as, but not limited to, elderly individuals, injured individuals, children, individuals with pre-existing conditions), the operational capability of the situational transportation asset, the location of the situational transportation asset, the types of transportation links, transit time on the transportation links, as well as other factors described herein.

In some embodiments, the transit disruption response system assigns a corresponding value to each factor of the foregoing factors. In one of such embodiments, the transit disruption response system determines which situational transportation asset should be deployed based on an aggregate value of the corresponding values. In another one of such embodiments, the transit disruption response system determines the number of situational transportation assets that should be deployed based on the aggregate value. In some embodiments, the transit disruption response system forms an alternative transportation route and then designates situational transportation assets based on the distance of the respective situational transportation assets to the alternative transportation route, or to the nearest transportation station connected by the alternative transportation route. In some embodiments, the transit disruption response system determines the number of individuals affected by the transit disruption as well as the number of alternative transportation assets needed to transport all of the individuals, and dispatches the determined number of alternative transportation assets to transport the individuals.

In some embodiments, the transit disruption response system determines, based on at least some of the foregoing factors, priority values of alternative transportation routes of the transportation network, transportation links of the transportation routes, and transportation stations of the alternative transportation routes. The transit disruption response system then dispatches the available transportation assets based on respective the priority value of each alternative transportation route, transportation link, and transportation station. For example, the transit disruption response system, in response to determining that a football stadium filled with 50,000 individuals at the time of the transit disruption is located next to a first dock, and that a restaurant with 20 patrons at the time of the transit disruption is located next to a second dock, assigns a higher priority value to the first dock. The transit disruption response system then dispatches multiple passenger ferries to the first dock to prioritize picking up individuals at or near the football stadium. Similarly, the transit disruption response system, in response to determining a hospital housing vulnerable individuals is located next to the first dock and that an office building housing 20 healthy individuals is located next to a second dock, assigns the passenger ferry to prioritize transporting the vulnerable individuals from the first dock.

In some embodiments, where the situational transportation asset is an unmanned vehicle (such as an unmanned bus, ferry, or aircraft), the transit disruption response system is operable to provide data indicative of an alternative transportation route together with locations of transportation stations and a transportation destination along the alternative transportation route to the unmanned vehicle. In such embodiments, the transit disruption response system is communicatively connected to an onboard electronic device of the unmanned vehicle. Further, the transit disruption response system upon determining an alternative transportation route to transport individuals affected by the transit disruption, transmits data indicative of the alternative transportation route to the onboard electronic device. The transit disruption response system then automatically dispatches the unmanned vehicle to travel along the alternative transportation route, and to stop at transportation stations along the alternative transportation route. In one of such embodiments, the transit disruption response system also instructs the onboard electronic device the locations of transportation stations along the alternative transportation route, how long the corresponding unmanned alternative situational transportation asset should stop at different transportation stations, the number of expected individuals the unmanned situational transportation asset should pick-up or drop off, whether to divert from the current alternative transportation route (in response to a change to the transit disruption), or to operate the unmanned situational transportation asset to perform another action. In other embodiments, where certain situational transportation assets are operated by human operators, the transit disruption response system is operable to provide instructions to electronic devices of the human operators, or to electronic devices that are onboard the situational transportation assets.

In some embodiments, the transit disruption response system is also operable to communicate with individuals affected by the transit disruption to provide them with an up-to-date status of the transit disruption, locations of established transportation stations, how to travel to the established transportation stations, schedules of situational transportation assets operating at the transportation stations, as well as other information to help facilitate transporting the individuals. In one of such embodiments, where the transit disruption response system is communicatively connected to electronic devices of individuals affected by the transit disruption, the transit disruption response system is operable to provide up-to-date schedules of nearby situational transportation assets.

In some embodiments, the transit disruption response system dynamically analyzes the up-to-date status of the transit disruption and modifies existing or forms new alternative transportation routes based on changes in the transit disruptions. In one of such embodiments, the transit disruption response system forms different alternative transportation routes (including utilizing different transportation mediums) in response to changes to the transit disruptions. In another one of such embodiments, the transit disruption response system designates new transportation stations along the alternative transportation routes in response to changes to the transit disruptions. In further embodiments, the transit disruption response system dispatches different types of situational transportation assets and dispatches different numbers of situational transportation assets in response to changes to the transit disruptions. For example, the transit disruption response system, upon detecting seismic activity around the island of the foregoing example, establishes multiple alternative transportation routes from waterways and air routes connecting the island to the mainland. However, the transit disruption response system subsequently determines that the seismic activity is caused by terrorist activity.

The transit disruption response system, in response to determining that the transit disruption is caused by a terrorist attack, removes previously-established alternative transportation routes by air to facilitate government responders to shut down airspace traffic around the island. Further, the transit disruption response system replaces any transportation station proximate to the terrorist attack with newly-designated transportation stations further away from the terrorist attack to ensure the safety of individuals being transported as well as the safety of operators involved in the transportation operation. Further, the transit disruption response system also establishes new alternative transportation routes connecting the newly-designated transportation stations to transportation destinations on the mainland. In some embodiments, the transit disruption response system weighs a variety of factors (such as, but not limited to, the type of change to the transit disruption, the number of additional individuals affected by the change in the transit disruption, the location associated with the change in the transit disruption, the number of available situational transportation assets, as well as other factors described herein). In one of such embodiments, the transit disruption response system assigns a value to each corresponding factor and determines how to respond to the change in the transit disruption (such as by performing any combination of the foregoing operations) based on an aggregate value of the values of each corresponding factor.

The transit disruption response system is operable to generate recommendations to modify the situational transportation assets to improve the efficiency of the situational transportation assets and also to customize the operational capabilities of the situational transportation assets to respond to the ongoing transit disruption. Continuing with the foregoing island example, where the transit disruption response system has determined that the transit disruption is caused by a terrorist attack, the transit disruption response system is operable to analyze the terrorist attack to determine whether situational transportation assets (such as the passenger ferry and the vehicle ferry) may be modified to adopt the operational capabilities of the situational transportation assets to respond to the terrorist attack. For example, the transit disruption response system generates a recommendation to include a medical facility on the passenger ferry to treat any injured individuals. The transit disruption response system also generates a recommendation to modify the vehicle ferry (such as installing a barge loader, a crane, or other structures) to facilitate transportation of military vehicles as well as other governmental vehicles to be used in response to the terrorist attack.

As described herein, the transit disruption response system is operable to predict future transit disruptions. For example, the transit disruption response system, in response to determining that a hurricane is approaching an island from the west, is operable to predict an approximate time the transit disruption would occur (when the hurricane would affect the island), how long the hurricane would affect roadways of the island as well as roadways connecting the island to other nearby locations, how long the hurricane would affect waterways surrounding the island, how long the hurricane would affect airspace above the island, the number of individuals affected by the hurricane, the locations of such individuals, the locations of first responders, as well as the locations of the first responders. Moreover, the transit disruption response system is also operable to form alternative transportation routes, dispatch situational transportation assets to transport individuals on the island, and also generate recommendations to customize some of the situational transportation assets to perform hurricane-related response operations before the island is affected by the hurricane. For example, the transit disruption response system customizes vehicle ferries (or vehicle ferry systems) to specialize in transporting passenger vehicles in anticipation of an exodus of passengers seeking to transport their vehicles to the mainland. Similarly, the transit disruption response system is also operable to customize passenger ferries to include onboard medical facilities in anticipation of injuries caused by the approaching hurricane.

In some embodiments, the transit disruption response system is also operable to pre-plan for transit disruptions that may occur in the future. In one of such embodiments, the transit disruption response system is operable to analyze historical data, such as data indicative of previous natural disasters, to calculate the geographic region's vulnerability to a transit disruption caused by similar natural disasters. For example, the transit disruption response system analyzes historical seismic activities and determines that the geographic region has a 90% chance to experience an earthquake having a magnitude greater than 5.0 on the Richter scale within the next five years. In such embodiments, the transit disruption response system is operable to perform the operations described herein to pre-plan for such natural disaster by forming alternative transportation routes and transportation networks, designating transportation stations and transportation destinations, designating situational transportation assets to respond to the hypothetical disaster (including requesting designated situational transportation assets to travel to corresponding designated locations before the hypothetical disaster is predicted to occur), and generating recommendations to modify some of the situational transportation assets in anticipation of the hypothetical disaster. Similarly, the transit disruption response system is also operable to analyze data indicative of existing transportation links to determine the vulnerability of such transportation links to natural disasters, maintenance failures, and human-caused disasters. For example, the transit disruption response system analyzes the design specifications of a bridge connecting Manhattan and Brooklyn and determines that the bridge has a 1% chance of suffering from a maintenance failure within the next five years if no maintenance is performed on the bridge. The transit disruption response system, in response to determining the failure rate of the bridge due to lack of maintenance, determines (based on historical data) locations proximate the bridge that are suitable for passenger ferries (or passenger ferry stations) to dock, and designates such locations as transportation stations and transportation destinations in the event the bridge suffers a failure. The transit disruption response system also forms a contingent alternative transportation route along the waterway connecting the two pre-certified docks and provides instructions to one or more passenger ferries that operate nearby to travel along the contingent alternative transportation route to transport passengers along either side of the bridge in the event the bridge suffers a failure.

The transit disruption response system is further operable to predict a transportation link that is most vulnerable (or is more vulnerable than a threshold value) to a transit disruption and form alternative transportation links to alleviate traffic along the transportation link in the event of the transit disruption. The transit disruption response system is operable to apply a variety of metrics based on historical data to determine the value and the vulnerability of existing transportation links. In one of such embodiments, the transit disruption response system is also operable to prioritize available situational transportation assets based on the value and vulnerability of transportation links. In one of such embodiments, the transit disruption response system determines the value of a transportation link based on the number of individuals that would be impacted if the transportation link is not operational. For example, a failure of the Golden Gate Bridge, which has an average daily vehicle traffic of 100,000, would cause a greater disruption to commuters than a failure of a nearby bridge, which has an average daily vehicle traffic of 100. In such embodiments, the transit disruption response system would rate the Golden Gate Bridge as being more valuable than the other bridge. The transit disruption response system, in response to determining that the Golden Gate Bridge is more valuable relative to the nearby bridge, prioritizes available situational transportation assets to respond to a transit disruption due to a hypothetical failure of the Golden Gate Bridge. In the event that both the Golden Gate Bridge and the other bridge simultaneously fail, the transit disruption response system would dispatch available situational transportation assets to alleviate a transit disruption caused by the failure of the Golden Gate Bridge.

In another one of such embodiments, the transit disruption response system determines the value of the transportation link based on an approximate financial cost (such as financial costs incurred by individuals traveling on the transportation link, financial costs incurred by the local government, and financial cost incurred by the local economy) associated with the transportation link being not operational. In a further one of such embodiments, the transit disruption response system determines the value of the transportation link based on whether the transportation link would impact any pre-planned events (such as an official visit by a senior government official, holiday parade, as well as other pre-planned events).

In some embodiments, the transit disruption response system determines the vulnerability of a transportation link based on the likelihood the transportation link would be affected by a transit disruption (such as an earthquake, a hurricane, or a terrorist attack). In further embodiments, the transit disruption response system determines the value and the vulnerability of the transportation link based on whether the transportation link is utilized by first responders, whether transportation link has received up-to-date maintenance, and the cultural significance of the transportation link. In that regard, the transit disruption response system is operable to obtain data indicative of the foregoing information and to process the data to determine the value and vulnerability of the transportation link. In some embodiments, the transit disruption response system assigns a weighted value to each of multiple factors (including the factors mentioned in the previous sentences) associated with the value or vulnerability of the transportation link. Additional descriptions of the transit disruption response system and operations performed by the transit disruption response system are described in the paragraphs below and are illustrated in FIGS. 1-5.

FIG. 1 is a network environment 100 for planning for a transit disruption and also for responding to a transit disruption (actual or predicted) in accordance with one embodiment. The network environment 100 includes a transit disruption response system 102 that is communicatively connected to a first situational transportation asset 108, a second situational transportation asset 110, a user electronic device 120, and a third-party system 130 via a network 106. As described herein, situational transportation assets include ferries (passenger and cargo), buses, trains, air transport vehicles, as well as other land-based, air-based, and sea-based vehicles. In the depicted embodiment, the first situational transportation asset 108 is a bus and the second situational transportation asset 110 is a passenger ferry.

In some embodiments, each of the first and second situational transportation assets 108 and 110 includes an onboard electronic device (not shown). As defined herein, an onboard electronic device is any electronic device onboard a situational transportation asset and is communicatively connected to the transit disruption response system 102 to receive instructions from the transit disruption response system 102. In some embodiments, the onboard electronic device is also operable to execute instructions received from the transit disruption response system 102. Examples of instructions executed by the onboard electronic device include instructions to travel along a designated alternative transportation route, instructions to travel to one or more transportation stations, instructions to stop at each transportation station for a designated amount of time, instructions to travel to a transportation destination, instructions to travel along a new alternative transportation route, as well as other instructions transmitted from the transit disruption response system 102. In one of such embodiments, where the situational transportation asset is an un-manned vehicle, the onboard electronic device automatically executes instructions received from the transit disruption response system 102 to operate the corresponding situational transportation asset. In other embodiments, where an operator is present, or where the situational transportation asset is not an un-manned vehicle, the onboard electronic device is operable to provide instructions received from the transit disruption response system 102 for display and to recommend to the operator to perform the instructions received from the transit disruption response system 102.

In some embodiments, the onboard electronic device is also operable to provide status updates to the transit disruption response system 102. Examples of status updates include, but are not limited to the current location of the corresponding situational transportation asset, an alternative transportation route the situational transportation asset is designated to travel along, transportation stations the corresponding situational transportation asset has stopped at, transportation stations the corresponding situational transportation asset is traveling to, estimated time to reach the next transportation station, estimated time to reach the transportation destination, as well as other information related to the status of the corresponding situational transportation asset or individuals onboard the corresponding situational transportation asset. Examples of onboard electronic devices include laptop computers, tablet computers, smartphones, smart watches, PDAs, server systems, as well as similar electronic devices having hardware and software components operable to receive instructions from the transit disruption response system 102.

The transit disruption response system 102 may be formed from one or more work management stations, server systems, desktop computers, laptop computers, tablet computers, smartphones, smart watches, PDAs, as well as similar electronic devices having a processor operable to assess (or pre-plan for a predicted) a transit disruption, determine transportation links in a geographic region affected by the transit disruption, form alternative transportation routes from one or more transportation links, and dispatch situational transportation assets along the alternative transportation routes to transport individuals affected by the transit disruption (or, where the transit disruption is a predicted transit disruption, designate situational transportation asserts to respond to the predicted disruption). The transit disruption response system 102 includes or is communicatively connected to a storage medium, such as storage medium 104. The storage medium 104 stores instructions, which when executed by the processor of the transit disruption response system 102, causes the processor to perform the foregoing operations as well as other operations described herein.

The storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, the storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of the transit disruption response system 102. The storage medium 104, in addition to storing executable instructions, also stores various historical data, which the transit disruption response system 102 analyzes to respond to an ongoing transit disruption or to plan for a possible future transit disruption. Examples of the historical data include, but are not limited to historical data associated with prior natural disasters, weather patterns, population distribution of individuals in the geographic region, high density areas, locations of institutions where vulnerable individuals reside/congregate (such as, but not limited to, hospitals, schools, senior centers, and disability centers), layout and specification of existing public transportation infrastructures, and identifications and operational specifications of available situational transportation assets, as well as other historical data that may be analyzed to respond to an ongoing transit disruption or to plan for a future transit disruption.

The transit disruption response system 102 is also communicatively connected to one or more third-party systems or networks. Examples of third-party systems include weather station systems and networks, systems and networks government agencies (such as, but not limited to local law enforcement agencies, federal law enforcement agencies, international government agencies, the federal emergency management agencies, and local emergency management agencies), systems and networks of humanitarian organizations, social media networks, map-based systems (which contain data indicative of current as well as predicted future traffic conditions along different transportation links), public transportation systems and networks, as well as other third-party systems and networks operable to provide up-to-date or forecasted data to the transit disruption response system 102. In the depicted embodiment, the third-party systems and networks are collectively illustrated as third-party system 130. In some embodiments, the third-party system 130 provides the transit disruption response system 102 with up-to-date information regarding the transit disruption, individuals affected by the transit disruption, conditions of transportation links, alternative transportation routes, transportation stations, transportation destinations, as well as other points of interest within a transportation network, weather conditions, weather forecasts, as well as other up-to-date or forecasted data utilized by the transit disruption response system to respond to an ongoing transit disruption or to plan for a future transit disruption. In other embodiments, the third-party system 130 also stores various types of historical data, such as the historical data described in the previous paragraph.

The transit disruption response system 102, obtains an indication from the third-party system 130 of a transit disruption affecting a geographic region. In some embodiments, the transportation disruption response system 102 is operable to directly receive data indicative of an indication (such as, but not limited to, weather reports, police reports, ambulance reports, and military reports) from the third party-system 130. In other embodiments, the transportation disruption response system 102 is operable to analyze data received the third-party system 130 to determine whether a transit disruption is affecting the geographic region. In one of such embodiments, the transportation disruption response system 102 determines whether the third-party system 130 has received keywords indicative of a transit disruption within a period of time (such as the last minute, the last hour, the last day, or another quantifiable period of time). For example, where the third-party system 130 represents a social media network, the transportation disruption response system 102 is operable to analyze the number of keywords from user posts to determine the location of the transit disruption, the number of individuals affected by the transit disruption, transit links affected by the transit disruption, whether first responders have responded to the transit disruption, as well as transit links used by the first responders to respond to the transit disruption. In some embodiments, the transportation disruption response system 102 is operable to combine multiple sources of data (such as, but not limited to, a combination of data from social media networks and data from first responders) to verify the existence of the transit disruption, to geo-locate individuals, and to obtain up-to-date status of transportation links affected by the transit disruption.

As described herein, the transit disruption response system 102 is also operable to analyze data stored on the storage medium 104 or provided by the third-party system 130 to predict a transit disruption that may affect the geographic region in the near future (such as predicting a transit disruption from an approaching hurricane). The transit disruption response system 102 is further operable to analyze such data to predict a transit disruption that may affect the geographic region in the future (such as predicting a transit disruption due to a bridge failure). As described herein, the transit disruption response system 102 determines existing transportation links in the geographic region and available situational transportation assets, and forms alternative transportation routes from one or more transportation links. Each alternative transportation route is formed from land-based, sea-based, air-based, or a combination of the foregoing transportation links. Further, each alternative transportation route connects one or more transportation stations to a transportation destination. Additional descriptions of operations performed by the transit disruption response system 102 to form alternative transportation routes are described in the paragraphs below and are illustrated in at least FIG. 2.

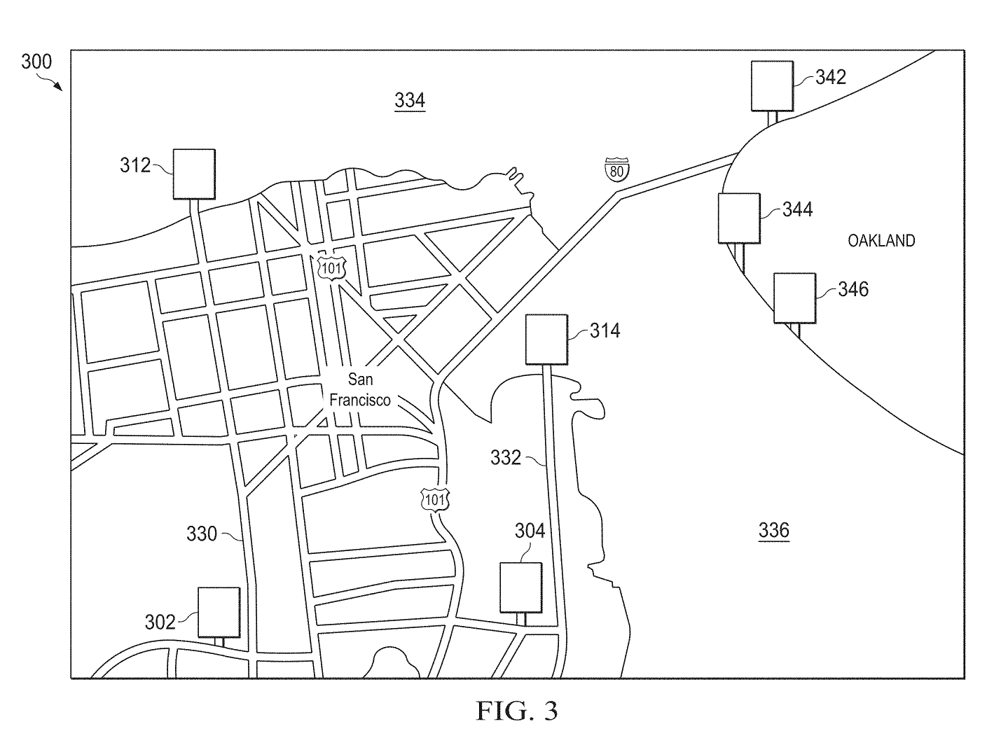

The transit disruption response system 102 is operable to link multiple alternative transportation routes to form a transportation network. For example, transit disruption response system 102 is operable to deploy the first situational transportation asset 108 along a land-based alternative transportation route that connects multiple transportation stations to a transportation destination that is located at a dock. The transit disruption response system 102 deploys the second situational transportation asset 110 along a sea-based alternative transportation route that connects the dock (transportation destination of the land-based alternative transportation route) to other docks further away from the transit disruption. Additional descriptions of transportation networks are provided in the paragraphs below and are illustrated in at least FIG. 3.

In some embodiments, the transit disruption response system 102 is communicatively connected to multiple user electronic devices of individuals within the geographic region, such as the user electronic device 120. User electronic devices 120 may include any electronic device operable to receive status information from the transit disruption response system 102. Examples of user electronic devices include, but are not limited to smartphones, tablet computers, smart watches, PDAs, laptop computers, desktop computers, as well as other electronic devices operable to receive transportation information from the transit disruption response system 102. Examples of transportation information, include but are not limited to information about the location of the nearest transportation station, estimated time of arrival of the next situational transportation system, location of the nearest transportation destination, as well as other transportation related information.

In some embodiments, the transit disruption response system 102 is also operable to receive a current location of the user electronic device 120 and coordinate transportation of individuals by the first and the second situational transportation assets 108 and 110. For example, the transit disruption response system 102, in response to determining the current location of the user electronic device 120, determines that user 121 is unlikely to reach a transportation station before the first situational transportation asset 108 is scheduled to depart from the transportation station. In one of such embodiments, the transit disruption response system 102 is operable to instruct the first situational transportation asset 108 to delay the scheduled departure time to accommodate the user 121. In another one of such embodiments, the transit disruption response system 102 is operable to divert another situational transportation asset (not shown) to pick up the user 121 at the transportation station. In further embodiments, the transit disruption response system 102 establishes a new transportation station at the current location of the user 121 or at a location proximate to the current location of the user 121, and requests the first situational transportation asset 108 or another situational transportation asset (not shown) to travel to the newly-established transportation station to transport the user 121.

In some embodiments, where the transit disruption is a predicted disruption, the transit disruption response system 102 is operable to determine a predicted location of the user 121 when the predicted transit disruption is predicted to occur. In one of such embodiments, the transit disruption response system 102 is further operable to request a situational transportation asset to travel to the predicted location ahead of the predicted event such that the user 121 may transport from the predicted location upon occurrence of the transit disruption. As such, the transit disruption response system 102, by pre-planning for transit disruptions, alleviates the impact of potential transit disruptions on individuals of the geographic region as well as the transportation system of the geographic region.

The network 106 can include, for example, any one or more of a cellular network, a satellite network, a personal area network (PAN), a local area network (LAN), a wide area network (WAN), a broadband network (BBN), a RFID network, a Bluetooth network, a device-to-device network, the Internet, and the like. Further, the network 106 can include, but is not limited to, any one or more of the following network topologies, including a bus network, a star network, a ring network, a mesh network, a star-bus network, a tree or hierarchical network, or similar network architecture. The network 106 may be implemented using different protocols of the internet protocol suite such as TCP/IP. The network 106 includes one or more interfaces for data transfer. In some embodiments, the network 106 includes a wired or wireless networking device (not shown) operable to facilitate one or more types of wired and wireless communication between the transit disruption response system 102, the first situational transportation asset 108, the second situational transportation asset 110, the user electronic device 120, the third-party system 130, as well as other electronic devices (not shown) and systems (not shown) communicatively connected to the network 106. Examples of the networking device include, but are not limited to, wired and wireless routers, wired and wireless modems, access points, as well as other types of suitable networking devices described herein. Examples of wired and wireless communication include Ethernet, WiFi, Cellular, LTE, GPS, Bluetooth, and RFID, as well as other types of communication modes described herein.

Although FIG. 1 illustrates two situational transportation assets 108 and 110 connected to the transit disruption response system 102 via the network 106, additional situational transportation assets (not shown) operable to perform various transportation operations described herein may also be communicatively connected to the transit disruption response system 102 via the network 106. For example, ferry systems 400 and 500 are operable to perform similar transportation operations as the second situational transportation asset 110. Additional descriptions of the ferry systems 400 and 500 are provided in the paragraphs below. Further, additional illustrations of the ferry systems 400 and 500 are provided in FIGS. 4 and 5. In some embodiments, the transit disruption response system 102 is operable to simultaneously perform multiple operations described herein to dispatch multiple situational transportation assets along one or more alternative transportation routes. In some embodiments, onboard electronic devices of the first and second situational transportation assets 108 and 110 are components of the transit disruption response system 102.

FIG. 2 is a tree diagram illustrating a process 200 to form an alternative transportation route in accordance with one embodiment. Although operations in the process 200 are shown in a particular sequence, certain operations may be performed in different sequences or at the same time where feasible. Further, in some embodiments, different combinations of some or all of the steps of the process 200 are performed to form the alternative transportation route.

At step 205, the transit disruption response system 102, upon determining the available situational transportation assets and the transportation links, accesses the storage medium 104 to obtain instructions that define how to form an alternative transportation route. In the depicted embodiment, instructions that define how to form the alternative transportation route are categorized by several factors, including transit disruption, available situational transportation assets, transportation links, and affected individuals.

At step 210, the transit disruption response system 102 accesses a first category of instructions that define how to form the alternative transportation route based on the (ongoing or predicted) transit disruption. In the depicted embodiment, the first category of instructions is further sub-divided into sub-categories of instructions, each defining how to form the alternative transportation route based on different aspects of the transit disruption.

At step 212, the transit disruption response system 102 applies instructions that define how to form the alternative transportation route based on the cause of the transit disruption. As described herein, the transportation may be caused by a natural disaster or by a human-caused disaster. In some embodiments, the instructions also define how to form the alternative transportation route to transport individuals from different types of natural disasters or from different types of human-caused disasters. For example, the transit disruption response system 102, in response to determining that the disaster is a tsunami that is approaching a peninsula connected to a mainland, forms an alternative transportation route from a coastal area of the peninsula to an area further inland, and forms an air-based transportation link connecting an airport in the inland area of the peninsula to another airport in the mainland. Alternatively, the transit disruption response system 102, in response to determining that the disaster is a snowstorm over the peninsula, forms an alternative transportation route from sea-based transportation links that connect the coastal area of the peninsula to another coastal area of the peninsula.

At step 214, the transit disruption response system 102 applies instructions that define how to form the alternative transportation route based on the severity of the transit disruption. In some embodiments, the number of alternative transportation routes and the average number of transportation stations per alternative transportation route are proportional to the severity of the transit disruption (or the predicted transit disruption). For example, if the transit disruption is caused by a failure of the only bridge that connects the peninsula of the foregoing example with the mainland, then the transit disruption response system 102 forms an alternative transportation route that connects multiple transportation stations along the coastal region of the peninsula to a transportation destination along a coastal region of the mainland. On the other hand, if the transit disruption is caused by a failure of one of several rarely-used underwater tunnels that connect the peninsula and the mainland, then the transit disruption response system 102 forms an alternative transportation route that connects a single alternative transportation route on the peninsula to a transportation destination along the coastal region of the mainland.

In some embodiments, the transit disruption response system 102 evaluates the severity of the transit disruption and establishes a minimum distance between the epicenter of the transit disruption and the nearest transportation station. For example, the transit disruption response system 102, in response to determining that the transit disruption is due to a car accident on an interstate, establishes a transportation station proximate a nearby off-ramp. Alternatively, the transit disruption response system 102, in response to determining that the transit disruption is due to a major act of terrorism, establishes the nearest transportation station more than a threshold distance away from the epicenter of the transit disruption to avoid inhibiting first responders from responding to the transit disruption and also to ensure the safety of the transportation process.

In some embodiments, the transit disruption response system 102 periodically or dynamically re-evaluates the transit disruption to obtain an up-to-date status of the transit disruption. At step 216 the transit disruption response system 102 applies instructions that define how to modify the alternative transportation route in response to a change in the transit disruption. For example, the transit disruption response system 102, in response to determining that a storm approaching the peninsula of the previous example has been upgraded from a tropical storm to a category 5 hurricane, is operable to shut down any sea-based alternative transportation routes, add additional transportation stations along coastal regions of the peninsula, and add additional alternative transportation routes connecting the peninsula to the mainland. The transit disruption response system 102 is also operable to dispatch additional situational transportation assets to the transportation stations before the category 5 hurricane reaches the peninsula to initiate evacuation efforts and to alleviate the impact of the category 5 hurricane.

At step 230, the transit disruption response system 102 accesses a second category of instructions that define how to form the alternative transportation route based on available transportation assets. At step 232, the transit disruption response system 102 applies instructions that define how to form the alternative transportation route based on the types of available situational transportation assets. For example, where the available situational transportation assets include passenger ferries and cargo ferries, the transit disruption response system 102 establishes a first transportation station designated to transport passengers, and dispatches the passenger ferries to the first transportation station. Further, the transit disruption response system 102 also establishes a second transportation station designated to transport vehicles and dispatches the cargo ferries to the second transportation station to transport vehicles from the peninsula to the mainland. At step 234, the transit disruption response system 102 applies instructions that define how to form the alternative transportation route based on the location of available situational transportation assets. In some embodiments, where an alternative transportation route connects multiple transportation stations, the transit disruption response system 102 dispatches available situational transportation assets to the closest transportation station. For example, where multiple transportation stations have been established along the coastal area of the peninsula of the foregoing example, the transit disruption response system 102 dispatches passenger ferries to the closest transportation station to improve the transportation efficiency.

At step 236, the transit disruption response system 102 applies instructions that define how to form the alternative transportation route based on the operational capacities of the available situational transportation assets. In some embodiments, the transit disruption response system 102 establishes the locations of alternative transportation routes based on whether the situational transportation assets may safety and efficiently reach the transportation station. For example, the transit disruption response system 102, in response to determining that available situational transportation assets include an amphibious vehicle, establishes an emergency transportation station on the rooftop of a partially-submerged home, and dispatches the amphibious vehicle to transport individuals stranded on the rooftop of the partially-submerged home. Similarly, the transit disruption response system 102, in response to determining that available situational transportation assets include a helicopter, establishes a transportation station on a mountaintop of a mountain surrounded by wildfire, and dispatches the helicopter to transport individuals stranded on the mountaintop. In some embodiments, the transit disruption response system 102 is operable to establish one or more transportation stations designated for evacuating vulnerable individuals such as, but not limited to, injured individuals, elderly, handicapped individuals, as well as other individuals that need medical or special assistance. In such embodiments, the transit disruption response system 102 dispatches situational transportation assets having the operable capabilities to transport vulnerable individuals to the designated transportation stations.

At step 250, the transit disruption response system 102 accesses a third category of instructions that define how to form the alternative transportation route based on transportation links of the geographic region. Transit disruptions sometimes damage or destroy existing transportation links in the geographic region. As such, the transit disruption response system 102 determines which transportation links may be utilized by situational transportation assets. At step 252, the transit disruption response system 102 applies instructions that define how to form the alternative transportation route based on the available transportation links. For example, if the transit disruption response system 102 determines that an earthquake has destroyed two out of five docks along a coastal region of the peninsula, then the transit disruption response system 102 is operable to designate the three remaining docks as transportation stations and form an alternative transportation route connecting the three remaining docks to another dock on the mainland. In some embodiments, the transportation disruption response system 102 also determines the operational capacity of the alternative transportation route to determine whether the alternative transportation route may be utilized during a transit disruption as well as how to improve transportation along the alternative route. Continuing with the foregoing example, where a first dock of the three remaining docks is configured to transport vehicles, the transportation disruption response system 102 is also operable to route alternative transportation assets configured to pick up vehicles to the first dock, and to route alternative transportation assets configured to pick up individuals to the other two docks.

In some embodiments, the transit disruption response system 102 evaluates a transit time along one or more transit links of the geographic region. In one of such embodiments, the transit disruption response system 102 is operable to obtain traffic data from the third-party system 130 and determine the transit time along one or more of the transit links of the geographic region. At step 254, the transit disruption response system 102 applies instructions that define how to form the alternative transportation route based on an average transit time along the transportation link. For example, the transit disruption response system 102, in response to determining that an average transit time along a land-based transportation link that connects the peninsula to the mainland is twice as long as an average transit time along a sea-based transportation link that connects the peninsula to the mainland, forms the alternative transportation route (or a part of the alternative transportation route) from the sea-based transportation link to reduce the transit time along the alternative transportation route. In some embodiments, the transit disruption response system 102 is also operable to connect different types of transportation links (such as a land-based transportation link to a sea-based transportation link) to reduce the overall transit time.

In some embodiments, the transit disruption response system 102 monitors transportation links utilized by first responders to respond to the transit disruption. At step 256, the transit disruption response system 102 applies instructions that define how to form the alternative transportation route based on whether some of the transit links in the geographic region are used by first responders. In some embodiments, the transit disruption response system 102 avoids transportation links used by the first responders to avoid inhibiting the first responders from responding to the transit disruption. In some embodiments, the transit disruption response system 102 also forms designated routes to facilitate transportation of first responders and vehicles used by the first responders. In one of such embodiments, where a terrorist attack has occurred on the peninsula of the foregoing example, the transit disruption response system 102 is operable to form a route connecting a dock on the mainland to a dock on the peninsula to transport military personnel and equipment from the mainland to the peninsula.

In some embodiments, the transit disruption response system 102 also establishes new transportation links. At step 258, the transit disruption response system 102 applies instructions that define how to form the alternative transportation route from newly-formed transportation links. In one of such embodiments, some of the newly-formed transportation links are formed as a result of the transit disruption. For example, a waterway may be formed from a flooded roadway. The transit disruption response system 102, in response to determining a newly-formed waterway, utilizes the newly-formed waterway to reach one or more transportation stations. In other embodiments, new transportation links may be established during emergencies. For example, temporary docks may be constructed to establish transportation stations. In such embodiments, the transit disruption response system 102 forms an alternative transportation route that connects the temporary docks to a transportation destination to transport individuals at the temporary docks. In some embodiments, the transportation disruption response system 102 also establishes alternative transportation routes to prepare for potential transit disruptions. In one of such embodiments, the transportation disruption response system 102 simulates a potential disruption, evaluates whether new transportation links (such as, but not limited to, whether the new transportation links have been approved for use, whether the new transportation links should be modified for use in the event of the potential disruption, and how to modify the new transportation links) may be formed in the event of the potential disruption. In such embodiments, the transportation disruption response system 102 communicates with regulatory authorities to provide recommendations to modify the existing transportation network to form the new transportation links. Examples of such modifications include, but are not limited to, adding new transportation stations, modifying operational capabilities of existing transportation stations and transportation destinations (such as retrofitting existing docks to handle additional traffic, injured individuals, as well as different types of cargo).

At step 270, the transit disruption response system 102 accesses a fourth category of instructions that define how to form the alternative transportation route based on individuals affected by the transit disruption. In some embodiments, the transit disruption response system 102 obtains the current location of individuals affected by the transit disruption. In the embodiment of FIG. 1, user electronic devices such as the user electronic device 120 and third-party systems such as the third-party system 130 are operable to provide the transit disruption response system 102 with locations of some of the individuals affected by the transit disruption. In some embodiments, the number of transportation stations, as well as the locations of the transportation stations, are based on the current location of the individuals affected by the transit disruption and the total number of individuals that need to be transported. At steps 272 and 274, the transit disruption response system 102 applies instructions that define how to form the alternative transportation route based on the current locations of the affected individuals and how to form the alternative transportation route based on the number of affected individuals, respectively. For example, the transit disruption response system 102, in response to determining the location of the individuals and the number of the individuals, establishes an alternative transportation route having transportation stations, one of which is within a threshold walking distance (such as within 100 feet, 200 feet, or another quantifiable distance) from the current location of a threshold number or percentage (such as at least 80%, at least 90% or another quantifiable percentage) of the total number of individuals.

In some embodiments, the transit disruption response system 102 customizes an alternative transportation route to accommodate vulnerable individuals. At step 276, the transit disruption response system 102 applies instructions that define how to form the alternative transportation route based on possible injuries to some of the individuals. For example, the transit disruption response system 102 establishes transportation stations in front of each hospital, nursing center, special needs center, and preschool to facilitate transportation of vulnerable individuals who may take longer to transport and may be more susceptible to hazards directly or indirectly caused by the transit disruption.

Although the foregoing paragraphs describe four categories of instructions that define how to form the alternative transportation route, the instructions may be organized into a different number of categories. Further, although some of the foregoing paragraphs describe forming alternative transportation routes to respond to ongoing transit disruptions, operations described in the foregoing paragraphs may also be executed to form alternative transportation routes used to respond to hypothetical transit disruptions. Further, in some embodiments, where multiple instructions that define how to form the alternative transportation route are applicable, the transit disruption response system 102 is operable to apply each applicable instruction and to determine how to form the alternative transportation route based on all applicable instructions. Further, the transit disruption response system 102 is operable to execute the instructions described in the foregoing paragraph to simultaneously form multiple alternative transportation routes and to connect the alternative transportation routes to form a transportation network.

FIG. 3 is an illustration of a transportation network 300 formed from multiple transportation links 330, 332, 334, and 316 in accordance with one embodiment. The transportation network 300 is formed from roadways such as Interstate 180, and roadways 330 and 332 in San Francisco. The transportation network 300 also includes waterways 334 and 336 around San Francisco. In the depicted embodiment, Interstate 180 which connects San Francisco with Oakland is out of service. The transit disruption response system 102, in response to determining that Interstate 180 is out of service, determines available transportation links that connect San Francisco to Oakland. In the depicted embodiment, the transit disruption response system 102 forms a first alternative transportation route and a second alternative transportation route from roadway 330 and waterway 336 and from roadway 332 and waterway 334, respectively, to transport individuals from different areas of San Francisco to Oakland. The transit disruption response system 102 then performs operations described herein to determine which situational transportation assets should be deployed along the transportation links 330, 332, 334, and 336 to transport individuals affected by the 180 shutdown from San Francisco to Oakland (and vice versa).

In the depicted embodiment, the transit disruption response system 102 dispatches buses, such as the first situational transit asset 108 to first and second transportation routes to pick up individuals seeking to travel to third and fourth transit stations 312 and 314 along first and the second transportation links 330 and 332, respectively. In some embodiments, the transit disruption response system 102 establishes additional transportation stations along the first and the second transportation links 330 and 332 to facilitate transportation of individuals along the first and the second transportation links 330 and 332 respectively. In the depicted embodiment, the third and fourth transportation stations 312 and 314 are not only bus stations, at which passengers may board buses, but are also ferry stations, at which passengers and vehicles may board ferries. In some embodiments, ferry stations, such as the ferry stations 400 and 500 depicted in FIGS. 4 and 5 are deployed at the third and fourth transportation stations 312 and 314. In one of such embodiments, individuals may board passenger ferries that are docked at the third and fourth transportation stations 312 and 314. In another one of such embodiments, vehicles, such as buses that travel along the first and the second transportation links 330 and 332, may board vehicle ferries docked at the third and fourth transportation stations 312 and 314. The transit disruption response system 102 then dispatches ferries docked at the third transit station to travel across the third transportation link 334 to fourth transit station and the fourth transit stations to travel across third transportation link 334 to dock at fifth transportation station 342 and dispatches ferries docked at the fourth transportation station 314 to travel across fourth transportation link 336 to dock at one of sixth and seventh transportation stations 344 and 346. Individuals and vehicles onboard the ferries then disembark the ferries and travel to a transportation designation (not shown) in Oakland.

In some embodiments, the transit disruption response system 102 is operable to determine an estimated transit time along the first, second, third, and fourth transportation links 330, 332, 334, and 336 and provide the estimated transit time to user electronic devices of individuals onboard the first and second situational transportation assets 108 and 110, as well as user electronic devices of other individuals waiting at the first, second, third, and fourth transportation stations 302, 304, 312, and 314. In some embodiments, where individuals need additional boarding time, the transit disruption response system 102 is operable to request situational transportation assets, such as the first and the second situational transportation assets 108 and 110 to delay departure. In further embodiments, the transit disruption response system 102, in response to determining a change in the transit disruption, is operable to dynamically modify the transportation links 330, 332, 334, and 336, modify the location of existing transportation stations 302, 304, 312, 314, 342, 344, and 346, as well as add new transportation stations and transportation destinations (not shown) to the first, second, third, and fourth transportation links 330, 332, 334, and 336. For example, the transit disruption response system 102, in response to determining an increase in the number of individuals seeking to travel to Oakland (such as during rush hour) is operable to form temporary new docks along the shores of San Francisco and Oakland, dispatch additional passenger and vehicle ferries to the new docks, and form additional transportation links (such as airways or alternative roadways) to transport individuals and vehicles from San Francisco to Oakland.

FIG. 4 is an illustrative embodiment of a ferry system 400. The ferry system 400 includes a ferry 402 that is operable to transport multiple vehicles 434 across a waterway 438. The system also includes a barge 404, which may be coupled to the ferry 402 by a tow cable or similar coupling mechanism. The barge has a first, land-facing end and a second, ferry-facing end, which may for simplicity be referred to as a first end 440 and second end 442, respectively. In some embodiments, a ferry-side ramp 408 extends across a gap between the ferry-facing second end 442 of the barge 404 and the adjacent end of the ferry 402. These adjacent ends may also be referred as the barge side of the ferry and the ferry side of the barge, respectively.

In the embodiment of FIG. 4, the first end 440 of the barge 404 is coupled to a bridge 410 at a barge ramp 406 that provides a path for vehicles 434 to be driven onto the barge 404 and subsequently onto the ferry 402 via the ferry-side ramp 408. The bridge 410 is supported by a piling 416 and pile cap 418, and is positioned on a hinge 422 that acts as a coupling between the bridge 410 and the supporting pile cap 418. A dock-side ramp 406 extends from the first end of the barge 404 to the bridge 410.

Between the bridge 410 and a landing 436, which may be a dock, warf, pier, beach, river bank, adjacent roadway, or similar feature, the system 400 includes decks 412. Each deck 412 is in turn supported by a girder structure 420 that rests atop pile caps 418. The pile caps 418 are turn are supported by pilings 416 that are driven into the seabed or riverbed below the mudline 424 to provide structural support to the overlying components. Joint cover plates 414 are positioned to cover the gaps between the landing 436 and first deck 412, between the decks 412, and between the bridge 410 and adjacent deck 412.

When the ferry 402 and barge 404 are in a docked configuration, the landing 436, decks 412, cover plates 414, bridge 410, dock-side ramp 406, barge 404, and ferry-side ramp 408 form a vehicular pathway from a roadway to the ferry 402. In the embodiment of FIG. 4, the barge 404 has a hull depth that is substantially less than that of the ferry 402. Thereby the keel or bottom of the barge 404 extends a lesser distance from the water's surface 426 than that of the ferry 402, which allows the barge 404 to operate in shallower water where the mudline 424 is closer to the surface 426. The use of the barge 404 thereby allows the ferry 402 to load vehicles from a location where the ferry 402 would not otherwise be able to operate without running aground.

An alternative embodiment of a ferry system 500. The system 500 is in many respects analogous to the system 400 of FIG. 4, and like components are similarly numbered but indexed by 400. To that end, a ferry 502 is shown as having loaded vehicles 534 via a plurality of barges, shown here as a first barge 504 and a second barge 505. The second barge 505 is positioned adjacent a landing 536 and includes a dock-side ramp 507 at a first end. While two barges are shown, it is noted that the system 500 may include any suitable number of barges to provide a transitional vehicle path between a landing 536 and a ferry 502. For example, the system 500 may include one, two, three, or more barges arranged in series to provide a path over a shallow mud line 524 to the ferry 502.

The landings (436 and 536) described herein may be unconventional landings for a ferry 502 or, for that matter, any vessel. For example, the landing may simply be a location adjacent to a waterway that allows for land-vehicle access, but that is not typically used as a dock or loading point. The barge 504 may thereby be used to facilitate the loading of vehicles 534 onto the ferry 502 from landing locations that are typically not accessible to a ferry 502, such as waterside roadways or bridges, river banks, beaches, and other shoreline locations. In such instances, the dock-side ramp of the barge 504 or second barge 505 (or the dock-side ramp of the barge 404 described above) may provide loading access to a vehicular path onto the ferry from any such landing location rather than a conventional dock.

Each of the first barge 504 and second barge 505 may include a ballast system that enables the vessel to adjust the extent to which it floats above the water's surface 526. This adjustment enables the barge to achieve a suitable loading angle relative to the landing 536, and also to operate in shallow depths, where the mudline 524 is relatively close to the surface 526. At a second, ferry-facing end, the second barge 505 includes a ferry-side ramp 509, which is shown as being in a raised position. The dock-side ramp 507 of the second barge 505 is coupled to the first end of the second barge 505 by a coupling 531. Similarly, the ferry-side ramp 509 of the second barge 505 is coupled to the second end of the second barge 505 by a ferry-side coupling 533.

The first barge 504 may include the ballast system, and may thereby be controlled to operate at a buoyancy level that complements that of the ferry 502, or at a level that provides a reasonable transition between the second barge 505 and the ferry 502. Similarly, in some embodiments, the first barge 504, second barge 505, and/or ferry 502 may have an automatic ballast adjustment system that dynamically adjusts the buoyancy of the vessel based on the tidal changes, changes in weight distribution and changes during loading and unloading.

At a second, ferry-facing end, the first barge 504 includes a ferry-side ramp 508, which is shown as being in a lower, deployed position to provide a vehicular pathway from the first barge 504 to the ferry 502. The dock-side of the first barge 504, similarly includes a dock-side ramp 506 that is coupled to the first end of the first barge 504 by a coupling 530. Similarly, the ferry-side ramp 508 of the second barge 504 is coupled to the second end of the second barge 504 by a ferry-side coupling 532. In some embodiments, the dock-side ramps 506, 507 may be linearly offset from the ferry-side ramps 508, 509, so that if the barges 504, 505 are arranged in series, the adjacent ramps can be deployed simultaneously or independently without interfering with one another. The barges may be any suitable size and shape, but in a representative embodiment, each barge may have a generally rectangular surface having dimensions of approximately 400 feet in width and 300 feet in length.

It is noted that in some embodiments, the barges 504, 504 and ferry 502 may operate together to effectively increase the carrying capacity of the ferry system by augmenting the carrying capacity of the ferry 502 with that of the barge 504 or barges 504, 505.

One or both of the dock-side ramps 506, 507 and ferry side ramps 508, 509 may include a hydraulic or electric control system that allows the ramps to be easily deployed and maintained. To that end, each vessel in the system may (or may not) be equipped with a ramp at each end for the loading and unloading of vehicles. For example, each barge 504, 505, may include a dock-side ramp 506, 507 and a ferry side ramp 508, 509 that provides a suitable transition angle to allow a vehicle 534 to drive onto and off of the barge based on the vehicles expected ground clearance and wheel base. In some embodiments, the dock-side ramps and ferry side ramps may be interlocking. In such embodiments, at the coupling between the ferry 502 and a barge, a first portion of the ferry-side ramp may be included in the ferry 502 and a second portion of the ferry-side ramp may be included in the barge adjacent. The ramps described herein may be raise and lowered manually, using mechanical or electrical systems, or combinations thereof. For example, an electronically actuated hydraulic system may be used to raise and lower each ramp. In some embodiments, the specification of the second situational transportation asset 110 of FIG. 1 is similar or identical to ferry 402 or 502. In one of such embodiments, operations performed by the second situational transportation asset 110 of FIG. 1 may also be performed by ferry 402 or 502.

In some embodiments, the processor of the transit disruption response system 102 also determines a severity of the transit disruption and recommends multiple situational transportation assets to respond to the transit disruption. In some of such embodiments, the processor of the transit disruption response system 102, in response to predicting a severe transit disruption, designates multiple situational transportation assets to respond to the transit disruption. In other embodiments, the processor of the transit disruption response system 102 also provide recommendations to customize the operational capacities of the additional situational transportation assets to accommodate the situational transportation assets to respond to the transit disruption.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A method to respond to a transit disruption, the method comprising:
monitoring one or more channels of data for data indicative of a transit disruption affecting a geographic region inhibited by one or more individuals;
analyzing the data to determine whether the transit disruption is affecting a transportation link of a plurality of transportation links connecting the geographic region;
in response to a determination that a transportation link is being affected by the transit disruption:
obtaining, from a database containing the plurality of transportation links of the geographic region, locations of the plurality of transportation links;
determining which transportation link is being affected by the transit disruption;
forming an alternative transportation route from one or more transportation links of the plurality of transportation links, the one or more transportation links being connected to each other by one or more transportation stations, at which the one or more individuals board one or more situational transportation assets traveling along the alternative transportation route,
wherein alternative transportation route comprises:
a first transportation link configured to provide a first mode of transportation; and
a second transportation link configured to provide a second mode of transportation;
dispatching a first situational transportation asset operable to provide the first mode of transportation to transport at least one of the one or more individuals along the first transportation link; and
dispatching a second situational transportation asset operable to provide the second mode of transportation to transport at least one of the one or more individuals along the second transportation link.

2. The method of claim 1, wherein monitoring the one or more channels of data comprises monitoring one or more social media networks for data indicative of a transit disruption.

3. The method of claim 1, wherein monitoring the one or more channels of data comprises monitoring one or more communication channels of first responders for data indicative of a transit disruption.

4. The method of claim 1, further comprising determining a type of the transit disruption, wherein forming the alternative transportation route comprises selecting one or more transportation links of the plurality of transportation links based on the type of the transit disruption.

5. The method of claim 1, further comprising:
determining a number and type of available situational transportation assets that are available to respond to the transit disruption; and
determining service ranges of the available situational transportation assets,
wherein forming the alternative transportation route comprises forming the alternative transportation route based on the number and type of available situational transportation assets and the service ranges of the available situational transportation assets.

6. The method of claim 1, further comprising:
determining a set of transportation links used by first responders in response to the transit disruption; and
excluding the set of transportation links used by the first responders from being used to form the alternative transportation route.

7. The method of claim 1, further comprising:
determining locations of the one or more individuals,
wherein forming the alternative transportation route comprises forming the alternative transportation route from one or more transportation links that are proximate to the locations of the one or more individuals.

8. The method of claim 7, further comprising:
determining if at least one of the one or more individuals are vulnerable; and
in response to determining at least one vulnerable individual among the one or more individuals, prioritizing one or more situational transport vehicles to pick up the at least one vulnerable individual.

9. The method of claim 1, further comprising providing the one or more individuals with locations of one or more transportation stations along the one or more transportation links and estimated time of arrival of one or more situational transportation assets dispatched to the transportation stations.

10. The method of claim 9, further comprising:
in response to determining one or more new transportation stations along the one or more transportation links,
providing the one or more individuals with updated locations of available situational transportation stations along the one or more transportation links and an estimated time of arrival of the one or more situational transportation assets dispatched to the available situational transportation stations.

11. The method of claim 1, further comprising:
monitoring a change in the transit disruption;
in response to a determination of a change in the transit disruption;
forming a second alternative transportation route from one or more transportation links of the plurality of transportation links; and
dispatching one or more situational transportation assets along the one or more transportation links to pick up the one or more individuals.

12. A transit disruption response system, comprising:
storage medium; and
a processor operable to:
monitor one or more channels of data for data indicative of a transit disruption affecting a geographic region inhibited by one or more individuals;
analyze the data to determine whether the transit disruption is affecting a transportation link of a plurality of transportation links connecting the geographic region;
in response to a determination that a transportation link is being affected by the transit disruption:
obtain, from a database containing the plurality of transportation links of the geographic region, locations of the plurality of transportation links;
determine which transportation link is being affected by the transit disruption;
form an alternative transportation route from one or more transportation links of the plurality of transportation links, the one or more transportation links being connected to each other by one or more transportation stations, at which the one or more individuals board one or more situational transportation assets traveling along the alternative transportation route; and
dispatch a plurality of situational transportation assets along the one or more transportation links to transport at least one of the one or more individuals along the alternative transportation route.

13. The system of claim 12, wherein the processor is further operable to:
determine a type of the transit disruption; and
select the one or more transportation links based on the type of the transit disruption.

14. The system of claim 12, wherein the processor is further operable to:
determine a number and type of available situational transportation assets that are available to respond to the transit disruption; and
determining service ranges of the available situational transportation assets; and
select the one or more transportation links based on the number and type of available situational transportation assets and the service ranges of the available situational transportation assets.

15. The system of claim 12, wherein the processor is further operable to:
determine a set of transportation links used by first responders in response to the transit disruption; and
exclude the set of transportation links used by the first responders from being used to form the alternative transportation route.

16. The system of claim 12, wherein the processor is further operable to:
determining locations of the one or more individuals; and
select one or more transportation links that are proximate to the locations of the one or more individuals to form the alternative transportation route.

17. The system of claim 16, wherein the processor is further operable to:
determine if at least one of the one or more individuals are vulnerable; and
in response to a determination that at least one vulnerable individual among the one or more individuals, prioritize one or more situational transport vehicles to pick up the at least one vulnerable individual.

18. The system of claim 12, wherein the processor is further operable to provide the one or more individuals with locations of one or more transportation stations along the one or more transportation links and estimated time of arrival of one or more situational transportation assets dispatched to the transportation stations.

19. The system of claim 12, wherein the processor is further operable to:
monitor a change in the transit disruption;
in response to a determination of a change in the transit disruption;
form a second alternative transportation route from one or more transportation links of the plurality of transportation links; and
dispatch one or more situational transportation assets along the one or more transportation links to pick up the one or more individuals.

20. A method to prepare for a transit disruption, the method comprising:
determining a plurality of transportation links in a geographic region, the geographic region being inhabited by a population;
evaluating, a vulnerability of one or more transportation links of the plurality of transportation links to a transit disruption;
determining a plurality of situational transportation assets available to support the geographic region during the transit disruption;
forming an alternative transportation route from at least one transportation link of the plurality of transportation links to transport individuals of the population, the alternative transportation route connecting one or more transportation stations, at which the individuals board one or more situational transportation assets, to a transportation destination, at which the individuals disembark from the one or more situational transportation asset; and
designating a situational transportation asset to respond to the transit disruption.
